(19) United States
(12) Patent Application Publication
(10) Pub. No.: US 2021/0156315 A1
(43) Pub. Date: May 27, 2021

(54) METHOD AND SYSTEM FOR EVALUATING THE TECHNICAL CONDITION OF GAS TURBINE ASSEMBLIES

(71) Applicant: JOINT STOCK COMPANY "ROTEC", Moscow (RU)

(72) Inventors: Mikhail Valeryevich LIFSHITS, Moscow (RU); Oleg Grigoryevich KLIMENKO, Lytkarino (RU); Daria Nikolaevna SKRABATUN, Rasskazovo (RU)

(21) Appl. No.: 17/048,774

(22) PCT Filed: Apr. 18, 2019
(86) PCT No.: PCT/RU2019/050045

§ 371 Date: Oct. 19, 2020

(30) Foreign Application Priority Data
Apr. 18, 2018 (RU) 2018114300

(51) Int. Cl. F02C 9/00; G01M 15/14

(52) U.S. Cl. CPC F02C 9/00; F05D 2270/303; F05D 2220/32; G01M 15/14

(57) ABSTRACT

The invention relates to a system for evaluating the technical condition of gas turbine assemblies on the basis of temperature fields, and is directed toward more accurately determining a temperature deviation from an initial value. In a method for remotely monitoring the technical condition of turbine assemblies, the temperature of a gas stream passing from the combustion chambers through the gas ducts and the blade assembly is measured in a turbine, at the outlet thereof, at different time points by means of thermocouples; temperature indices of the gas turbine are obtained for each time point, and the temperature indices obtained from each thermocouple are converted into vector quantities, wherein the temperature of the thermocouple is the vector magnitude, and the angular position of the thermocouple in the plane of the exhaust is the vector direction; on the basis of the vector quantities obtained, a resultant temperature vector value is generated, the head of said resultant vector being the epicentre of a heat field; a coordinate grid is constructed and the head of the resultant vector is plotted thereon; the heads of resultant vectors calculated on the basis of incoming data about new temperature indices at the turbine outlet in different time intervals are added each time to the coordinate grid; the extent of deviation of the vector heads from an initial value is determined.

### FIELD OF THE INVENTION

The invention relates to the system of gas turbine assemblies technical evaluation by temperature fields and applied method.

### BACKGROUND

Power engineering is one of the leading and the most complex industries. In the course of power engineering development, the economic efficiency of power enterprises is steadily improved that results in electric and heat power production and transfer cost reduction. Electric power production and delivery to consumers are characterized by some peculiarities which are characteristic of this process compared to production and distribution of the other products. Firstly, it is continuity and high rate of power production and transportation, and secondly—impossibility of its storage.

As in many other industries, efficiency in power engineering is achieved by two ways.

The first one relates to upgrading of newly launched equipment towards reduction of heat rate per energy output unit to reduce cost fuel factor and towards unit cost reduction and improvement of this equipment reliability to reduce depreciation charges. Increase of units rating and their automation reduce construction and service costs.

In order to reach these objectives new systematic scientific studies aimed at development of new processes and upgrading of existing processes, search of new materials, etc. Implementation of these activities requires considerable costs and affects the efficiency of newly constructed power stations operation.

The second way—rational operation of existing power units which involves selection of the most advantageous configuration of working equipment, carrying out repair and diagnostic activities within the optimal terms, the most optimal distribution of load between working units. Rational operation of each individual unit consists in implementation of the most cost-effective mode taking into account the specific features of this particular unit.

One of the fundamental peculiarities of the power production is strict dependency of power stations operation mode on electric power consumption mode. Power consumption changes under the influence of different factors: production process features, shift-working arrangement, climatic factors, etc. Domestic household, which share in the most world countries steadily increases, makes considerable contribution to irregularity of power consumption schedules.

Currently, practically all generation objects are equipped with comprehensive APCS (automated process control systems) The APCS by their nature are not tools for analysis of condition changes, though in many respects they serve to prevent emergency events. Statistics of incidents and emergencies attests to the fact that autonomous and built-in APCS systems for monitoring and diagnostics of power-generating equipment are not effective enough [1].

Condition monitoring is based on comparison between parameter values and criteria correspondence to their limits and norms and parameters with reference power characteristics. Such systems function as a set of modules analyzing operation of different subsystems of monitoring object. Labour-consuming automated analysis of the monitoring systems operation is supposed to be done by a large number of experts to determine changes in technical condition and to search for their causes. The applied methods are powerless in case of untrustworthy or incomplete information about limits and norms of key process parameters, criteria or relationship between parameters. In most cases this is the cause of untimely revealing of emergent defects, their uncontrolled growth, when technical condition is “operable”, and as a consequence, it results in “inoperable” or “limit” state of the object. Maintenance activities are generally carried out after operation of warning or emergency alarms. Equipment defects are detected after opening the equipment that results in “insufficient” repairs due to lack of necessary spare parts and technical solutions to resolve the problems.

Nowadays it is important not only to determine condition type, in particular: “operable”, “partially operable”, “limit”, but also to monitor changes in the condition already determined [2]. The most important task is monitoring the changes in equipment “operable” condition, which are caused by nucleation of any defect of multiple parts, assemblies and systems to detect undesirable trends and make a forecast of their development as to prevent incidents and emergencies.

Technical diagnosis is a set of activities which enables to study and detect signs of equipment malfunction (operability), establish methods and means which help to make a conclusion (make a diagnosis) about malfunction (defect) presence (absence). In other words, technical diagnosis enables to make technical evaluation of the object under investigation. Such diagnosis is mainly focused on search and analysis of internal causes of equipment malfunction.

The diagnosis results can include:

1. Determining the state of the equipment being diagnosed (equipment technical evaluation).

2. Specifying the defect type, its severity, location, causes, that serves as a basis for decision about subsequent equipment operation (shutdown for repair, additional inspection, continuing the operation, etc.) or about complete replacement of the equipment.

3. Forecast about terms of further operation—assessment of electric equipment residual operation life.

Consequently, it may be concluded that with the purpose of defect prevention (or detection at early stages of formation) and maintaining of equipment operation reliability it is necessary to apply equipment monitoring in the form of diagnosis system.

The main methods of non-destructive testing (NDT) which are the most frequently used for electrical equipment are listed below:

1) magnetic;

2) electrical;

3) eddy current;

4) radio-wave,

5) thermal;

6) optical;

7) radiation;

8) acoustic;

9) penetrant (dye penetrant inspection and leak detection).

Thermal methods of testing according to GOST 53689-2009 are based on recording of thermal or temperature fields of the object under monitoring.

Development of gas turbines accompanied by increase of fluid initial parameters, their uprating and improvement of maneuvering characteristics has brought up a wide variety of issues related to ensuring robustness and durability of gas turbine parts. Among wide range of these issues the further improvement of calculation methods and studies of cooling systems and thermo-stressed state of gas turbine blades are of prime importance.

Currently, there are many known solutions implementing processes of gas turbine assemblies technical evaluation and forecasting of different assemblies failure.

It is known the method of detection of partial flame failure in gas turbine engine (patent U.S. Pat. No. 8/474/269 B2, Siemens AG, Feb. 7, 2013). In this patent the gas turbine has a gas channel to flow moving gas and several combustion chambers, provided that each of the combustion chambers leads to the gas channel and contains a burner. The method contains the following steps: measurements of the first temperature in a given time in each of at least two measuring points located downstream from the combustion chambers in the gas channel, measurements of the second temperature in a given time in each of at least two burners and detection of partial flame failure from the measurements of the first temperatures and measurements of the second temperatures, and detection of partial flame failure includes the step of determining the first detection parameter, with the first detection parameter being determined from the rate of change between the first temperature measurements variety in different measuring points.

It is known the method of monitoring the gas turbine fuel temperature (patent application US 2014033731 A1, ROLLS ROYCE DEUTSCHLAND, Jun. 2, 2014), in which the parameters are determined as input values and compared to nominal values optimized for emission, after that, the fuel optimal temperature is determined and heated or cooled fuel is supplied to the combustion chamber respectively.

These solutions do not provide with a possibility of remote monitoring of gas turbine assemblies condition by temperature fields that prevents from quick and precise determination of possible future malfunction of gas turbine assemblies.

### DISCLOSURE OF THE INVENTION

Thermal methods of testing are based on measurement, evaluation and analysis of the monitored objects temperature. The basic condition for using the diagnosis by means of thermal NDT is availability of heat flows in the object being diagnosed.

Temperature is the most universal reflection of any equipment state. Practically, at any operation mode different from normal the temperature change is the very first indicator of faulty condition. Temperature reactions at different operation modes due to their universality occur at all phases of electrical equipment operation.

One of the serious problems occurred during operation of gas turbine units is failure of the first stage rotor and stator blades of high-pressure turbine (HPT) caused by combustion products temperature field nonuniformity.

Hot combustion gases heat the gas turbine blades outer surface, however, these blades could be cooled down inside, for example, with air supplied by compressor, or with steam supplied from heat disposal system. Therefore, temperature gradient occurs between outer and inner part of the cooled down blades. Provided that, the most loaded elements of the gas turbine are the first stage rotor blades the destruction of which is prevalently caused by thermal fatigue.

The purpose of the invention is creation of a new system and method of gas turbine assemblies technical evaluation by temperature fields that enables to detect changes in objects condition at the early stages and forecast failure of as critical elements of the monitored object as the object as a whole.

The technical result is improving the accuracy of determination of temperature deviation from initial value.

Owing to this determination of temperature deviation the severe malfunctions of gas turbine assemblies are revealed.

The claimed result is achieved by means of implementation of computerized method of remote monitoring of gas turbine assemblies condition by temperature fields, which consists of some steps involving as follows:

measuring the temperature of gas flow from combustion chambers through gas ducts and blading at the gas turbine outlet by means of thermocouples at different moments in time;

obtaining the gas turbine said temperature values measured by thermocouples;

transforming the temperature values obtained from each thermocouple for each moment of time into vector values, where thermocouple temperature is a vector module and thermocouple angular arrangement in exhaust plane is its direction;

forming the resultant temperature vector value based on the obtained vector values, and the end of this resultant vector is the epicenter of thermal field;

making the coordinate grid with plotting the resultant vector end on it;

every time adding the resultant vector ends, calculated based on incoming data on gas turbine outlet new temperature values at different moments in time, on the coordinate grid;

determining the value of new vector ends deviation from initial value on coordinate grid.

In a particular embodiment of the invention correction factors are used in case of asymmetrical arrangement of thermocouples.

In other particular embodiment of the invention the groups of thermocouples characterize operation of individual combustion chambers.

In other particular embodiment of the invention the coordinate grid is a polar coordinate system or Cartesian coordinate system.

In other particular embodiment of the invention the monitoring is carried online or off-line.

The claimed result is also achieved due to the gas turbine assemblies condition remote monitoring system, by gas flow temperature determined by thermocouples and by transmission of these values to the primary controllers, which are connected to the main APCS server of the monitored object intended for accumulation of data received from the controllers and subsequent transfer of the said data from the low-level zone of the remote monitoring system comprising at least the low-level server of the remote monitoring system, from which the gas turbine measured temperature data are transmitted to the top level zone of the remote monitoring system, which comprises the top level server configured to implement the above method of remote monitoring of gas turbine assemblies condition.

In other particular embodiment of the claimed system the thermocouples are arranged asymmetrically around the circumference and use correction factors which take asymmetry into account. Correction factors are calculated as the value of thermal field epicenter offset from coordinate center in X and Y coordinates in case of equality of temperatures of all thermocouples asymmetrically arranged. In a particular embodiment of symmetrical arrangement of thermocouples in case of temperatures equality the thermal field epicenter will be in the coordinate center, and correction factors will be 0.

In other particular embodiment of the claimed system the groups of thermocouples could characterize operation of individual combustion chambers.

In other particular embodiment of the claimed system the state change monitoring is carried online or off-line.

In other particular embodiment of the claimed system the data transmission network is the Internet.

In other particular embodiment of the claimed system the data transmission via the Internet is carried out through the protected data link.

In other particular embodiment of the claimed system the top level server is configured to transfer the monitored object state data to users' remote devices.

In other particular embodiment of the claimed system the data are transmitted to users' remote devices by wire and/or wireless communication.

In other particular embodiment of the claimed system the wire communication is LAN of Ethernet type.

In other particular embodiment of the claimed system the wireless communication is selected from the following group: Wi-Fi, GSM, WiMax or MMDS (Multichannel Multipoint Distribution System).

In other particular embodiment of the claimed system the monitored object state data are transmitted to users' remote devices by means of email messages and/or SMS messages and/or PUSH messages.

### BRIEF DESCRIPTION OF DRAWINGS

FIG. 1 illustrates system architecture of the gas turbine assemblies condition remote monitoring by temperature fields.

FIG. 2 illustrates the main steps of the claimed method implementation.

FIG. 3 illustrates arrangement of thermocouples at the gas turbine outlet.

### EMBODIMENT OF THE INVENTION

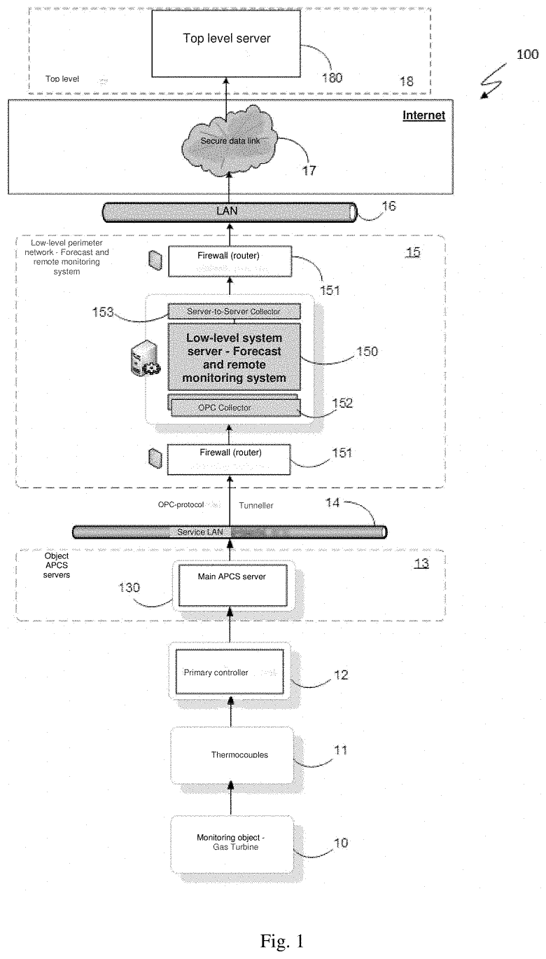

FIG. 1 illustrates general architecture of the claimed solution, in particular, the system of the gas turbine assemblies condition remote monitoring by temperature fields (100). The remote monitoring system (100) consists of the low (15) and top (18) level systems. Both levels are implemented at the servers (150, 180) performing special functions. The task of the low-level server (150) is data collection, primary processing, buffering and transmission to the top level server (180), which task is solution of analytical problems related to monitoring of gas turbine assemblies condition by temperature fields (monitoring object) (10).

Data collection and transmission is implemented on the basis of two-servers scheme. The process of data collection starts at the low level, gas turbine level (monitoring object) (10), where temperatures of combustion chambers and blading are recorded by thermocouples (11) arranged around the exhaust diffuser circumference.

Thermocouples (11) measure temperature in gas turbine individual sectors and indicate the condition of its assemblies. Based on the measurements results the obtained maximum temperature is recorded on thermocouples and minimum temperature is obtained. On this basis it is possible to determine a difference between maximum and minimum temperatures.

Thermocouple readings (11), namely the temperatures of the combustion chambers and blading, are transmitted to the primary controllers (12), from where they are transmitted to the main APCS server of the monitored object (130).

The low-level system server (150) of the system of the gas turbine assemblies condition remote monitoring by temperature fields (100) is installed in its own cabinet in special server room in the immediate vicinity of the available APCS servers of the monitored object (130). Data from the service network (14) formed by one or several APCS servers (130) are transmitted to the low-level server (150) of the system of the gas turbine assemblies condition remote monitoring by temperature fields. Data transmission to the low-level server (150) can be effected using OPC protocol (OLE for Process Control) and OPC tunneling technology.

The low-level zone of the system of the gas turbine assemblies condition remote monitoring by temperature fields (15) could be made in the form of perimeter network formed by means of firewalls (151), which receive data from APCS server (130) and transmit data to the top level zone (18). Such scheme isolates operation of the object APCS (130) and low-level system (15), and maintains security of received data in case of abnormal situations.

Process condition data received from thermocouples (11) of the gas turbine (10) are transmitted to the unified archive of the top-level server (180) of the system of the gas turbine assemblies condition remote monitoring by temperature fields. Data transmission to the top-level server (180) is effected by LAN, e.g. global Internet. These data can be transmitted via protected LAN data link, which ensures data transmission in real time with no loss in quality, using synchronization of low-level (15) and top level (18) servers (150, 180). Besides, obtaining full and complete data at the top level server (180) provides with a possibility of detailed analysis of object condition by experts working with the top level system (18), that enables to monitor gas turbine and its components (10) by efforts of these experts.

The top-level server (180) is configured to data analytical online processing automatically performed by the object mathematical model based on the formed reference parameters of the properly functioning object.

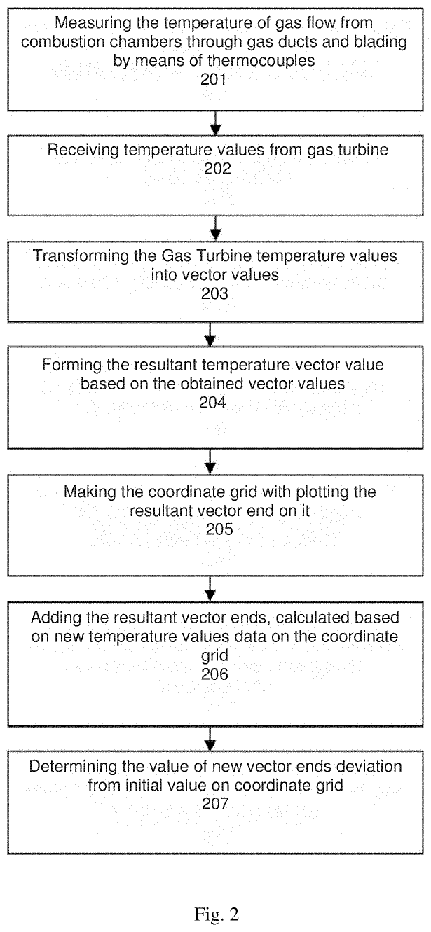

FIG. 2 illustrates the method (200), implemented in the said top level server (180), by means of which the gas turbine assemblies condition monitoring by temperature fields (10) is carried out.

The step (201) is measuring the temperature of gas flow from combustion chambers through gas ducts and blading by means of thermocouples (11).

The step (202) is receiving temperature values from gas turbine by top level server (180).

The step (203) is transforming the temperature values obtained from each thermocouple for each moment of time into vector values, where thermocouple temperature is a vector module and thermocouple angular arrangement in exhaust plane is its direction.

The step (204) is forming the resultant temperature vector value based on the obtained vector values, and the end of this resultant vector is the epicenter of thermal field.

The step (205) is making the coordinate grid with plotting the resultant vector end on it, and the step (206) every time adding the resultant vector ends, calculated based on incoming data on gas turbine outlet new temperature values at different moments in time, on the coordinate grid.

The step (207) is determining the value of new vector ends deviation from initial value on coordinate grid.

Transmission of the required information, in particular, at receiving signals about gas turbine (10) malfunction can be carried out by means of well-known wire and wireless communications, e.g.: Ethernet-type LAN (LAN), Wi-Fi, GSM, WiMax or MMDS (Multichannel Multipoint Distribution System), etc.

Information from the top level system (18) of the system of the gas turbine assemblies condition remote monitoring by temperature fields (100) can be transmitted to different remote computer devices, e.g. IBM PC-based HMI or mobile devices of the system users, e.g. smartphones, data tablets or laptops, receiving data from the top level server (180) by means of email messages and/or SMS messages and/or PUSH messages.

Monitoring of gas turbine (10) components can be performed via standard web browser and Internet portal intended for visualization of gas turbine (10) assemblies state parameters. Also, real time monitoring of gas turbine (10) assemblies is possible by means of special software application installed on users' devices.

Notification about beginning of the gas turbine assemblies limit state or necessity to check some gas turbine (10) assemblies, which further on could result in limit state or degradation, can be transmitted to devices until the server (180) in response to notifications sent receives a message that the notification has been viewed by user. This function can be implemented by sending electronic messages at fixed intervals or by special application or web-portal, which in response to identification of the user connected to the top level server (180) notification system, analyzes the status of receiving the said notification by the said user. The status can be linked to a change of notification parameter status at the server, which could be a record in the data base of response message receipt note from the user device.

The temperature field in the gas turbine is evaluated by thermocouples readings, at the gas turbine outlet.

The tendency to temperature increase downstream from gas turbine while its power remains constant testifies that temperature increases upstream from the gas turbine first stage, that in turns results in shorter life of hot gas path elements.

In contrast to traditional methods of recording, processing and visualization of readings of temperature sensors located downstream from the gas turbine last stage in the form of temperature graphs depending on time, load and other parameters, there has been developed a system of visualization of the turbine thermal field state according to readings of all sensors in the form of one rating displayed in the polar coordinate system in the form of radius vector Aφ (where A—rating, φ—angle) or in the form of radius vector projection in X, Y Cartesian coordinate system.

This rating is the Thermal Field Epicenter (TFE)—the resultant vector value of all readings of thermocouples arranged in the gas flow section plane.

TFE position is changed in the following cases:

change of combustion mode;

changes in combustion chamber operation (redistribution of primary air/gas flows, etc.);

seasonal factor.

TFE visualizer while processing data, transforms readings of all thermocouples into a single value—TFE position point on the coordinate plane at this point in time. Multiple TFE points plotted during operation monitoring of the specific turbine plant form characteristic zones (CharZ) of turboset basic and transient modes. Monitoring of CharZ position detects deviations of GTU elements condition at early stage of defects growth. Graphical representation of thermal field center is available in two variants—in polar coordinates with visualization of its changing in time and load (animation), and also in Cartesian coordinates, where changes of vector characteristics in time are plotted.

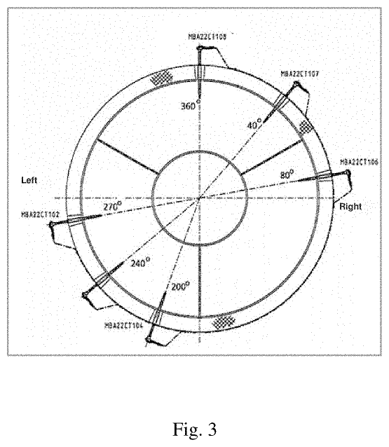

Exhaust gas temperature downstream of the turbine is measured by thermocouples. Each of the thermocouples is installed at certain angle relative to vertical plane (see FIG. 3).

Position of thermal field epicenter by thermocouples' readings and taking into account their spatial arrangement in X coordinate is determined by the ratio:

x=(T1*SIN αT1+T2*SIN αT2+ . . . +Tn*SIN αTn)/(SUM(T1:Tn))+kx

Position of thermal field epicenter by thermocouples' readings and taking into account their spatial arrangement in Y coordinate:

y=(T1*COS αT1+T2*COS αT2+ . . . +Tn*COS αTn)/(SUM(T1:Tn))+kx

where, αTn—position angle of n-thermocouple relative to zero position in the exhaust section plane;

kx and ky—factors taking into account TFE deviation from coordinate center at similar temperature value of all thermocouples.

The advantages of the claimed solution are as follows:

1. High sensitivity. Change of any thermocouple temperature by 1° C. at average measurement temperature of 550° C. causes change of TFE position by 0.002 units in X, Y coordinates. Provided that, CharZ of GTU operation at nominal load of 165-170 MW is limited with a square less than 0.04 unit on a side. That is to say, temperature spread in CharZ is about 10° C. and parameter variation above this level causes substantial offset of CharZ and, respectively, identification of the object state change.

2. Multiple decrease of real time monitoring parameters number.

3. Simplicity of implementation and application for different systems monitoring.

This description of the claimed invention discloses preferable embodiments of the claimed solution and shall not be interpreted as limiting the other particular embodiments, which are not beyond the claimed scope of protection and are obvious to persons skilled in the art.

### LIST OF REFERENCES

1. V. V. Kudryaviy Systemic destruction of the system//The first industry-specific electronic media RusCable.Ru, ed. No. ΦC77-28662. Aug. 3, 2016.

2. E. K. Arakelyan, G. D. Krokhin, V. S. Mukhin Concept of “soft” control and maintenance of power units based on intelligent diagnosis//Bulletin of Moscow Power Engineering Institute. 2008. No. 1. Page 14-20.

1. Computerized method of remote monitoring of gas turbine assemblies condition by temperature fields, which consists of the steps involving as follows:
measuring the temperature of gas flow from combustion chambers through gas ducts and blading at the gas turbine outlet by means of thermocouples at different moments in time;
obtaining the gas turbine said temperature values measured by thermocouples;
transforming the temperature values obtained from each thermocouple for each moment of time into vector values, where thermocouple temperature is a vector module and thermocouple angular arrangement in exhaust plane is its direction;
forming the resultant temperature vector value based on the obtained vector values, and the end of this resultant vector is the epicenter of thermal field;
making the coordinate grid with plotting the resultant vector end on it;
every time adding the resultant vector ends, calculated based on incoming data on gas turbine outlet new temperature values at different moments in time, on the coordinate grid;
determining the value of new vector ends deviation from initial value.

2. Method according to claim 1, wherein the correction factors are used in case of asymmetrical arrangement of thermocouples.

3. Method according to claim 1, wherein the groups of thermocouples characterize operation of individual combustion chambers.

4. Method according to claim 1, wherein the coordinate grid is a polar coordinate system or Cartesian coordinate system.

5. Method according to claim 1, wherein the monitoring is carried online or off-line.

6. The gas turbine assemblies condition remote monitoring system, by gas flow temperature determined by thermocouples and by transmission of these values to the primary controllers, which are connected to the main APCS server of the monitored object intended for accumulation of data received from the controllers and subsequent transfer of the said data from the lower level zone of the remote monitoring system comprising at least the lower level server of the remote monitoring system, from which the gas turbine measured temperature data are transmitted to the top level zone of the remote monitoring system, which comprises the top level server configured to implement the above method of remote monitoring of gas turbine assemblies condition according to claim 1.

7. The system according to claim 6, wherein the thermocouples are arranged asymmetrically around the circumference and use correction factors which take asymmetry into account.

8. The system according to claim 6, wherein the groups of thermocouples could characterize operation of individual combustion chambers.

9. The system according to claim 6, wherein the state change monitoring is carried online or off-line.

10. The system according to claim 6, wherein the data transmission network is the Internet.

11. The system according to claim 10, wherein the data transmission via the Internet is carried out through the protected data link.

12. The system according to claim 6, wherein the top level server is configured to transfer the monitored object state data to users' remote devices.

13. The system according to claim 12, wherein the data are transmitted to users' remote devices by wire and/or wireless communication.

14. The system according to claim 13, wherein the wire communication is LAN of Ethernet type.

15. The system according to claim 13, wherein the wireless communication is selected from the following group: Wi-Fi, GSM, WiMax or MMDS (Multichannel Multipoint Distribution System).

16. The system according to claim 15, wherein the monitored object state data are transmitted to users' remote devices by means of email messages and/or SMS messages and/or PUSH messages.

17. The gas turbine assemblies condition remote monitoring system, by gas flow temperature determined by thermocouples and by transmission of these values to the primary controllers, which are connected to the main APCS server of the monitored object intended for accumulation of data received from the controllers and subsequent transfer of the said data from the lower level zone of the remote monitoring system comprising at least the lower level server of the remote monitoring system, from which the gas turbine measured temperature data are transmitted to the top level zone of the remote monitoring system, which comprises the top level server configured to implement the above method of remote monitoring of gas turbine assemblies condition according to claim 2.

18. The gas turbine assemblies condition remote monitoring system, by gas flow temperature determined by thermocouples and by transmission of these values to the primary controllers, which are connected to the main APCS server of the monitored object intended for accumulation of data received from the controllers and subsequent transfer of the said data from the lower level zone of the remote monitoring system comprising at least the lower level server of the remote monitoring system, from which the gas turbine measured temperature data are transmitted to the top level zone of the remote monitoring system, which comprises the top level server configured to implement the above method of remote monitoring of gas turbine assemblies condition according to claim 3.

19. The gas turbine assemblies condition remote monitoring system, by gas flow temperature determined by thermocouples and by transmission of these values to the primary controllers, which are connected to the main APCS server of the monitored object intended for accumulation of data received from the controllers and subsequent transfer of the said data from the lower level zone of the remote monitoring system comprising at least the lower level server of the remote monitoring system, from which the gas turbine measured temperature data are transmitted to the top level zone of the remote monitoring system, which comprises the top level server configured to implement the above method of remote monitoring of gas turbine assemblies condition according to claim 4.

20. The gas turbine assemblies condition remote monitoring system, by gas flow temperature determined by thermocouples and by transmission of these values to the primary controllers, which are connected to the main APCS server of the monitored object intended for accumulation of data received from the controllers and subsequent transfer of the said data from the lower level zone of the remote monitoring system comprising at least the lower level server of the remote monitoring system, from which the gas turbine measured temperature data are transmitted to the top level zone of the remote monitoring system, which comprises the top level server configured to implement the above method of remote monitoring of gas turbine assemblies condition according to claim 5.
